(19) United States
(12) Patent Application Publication
(10) Pub. No.: US 2004/0213272 A1
(43) Pub. Date: Oct. 28, 2004

(54) Layer 2 switching device

(76) Inventors: Shinjiro Nishi, Yokohama (JP); Nobuo Shirai, Yokohama (JP)

Correspondence Address: KATTEN MUCHIN ZAVIS ROSENMAN, 575 MADISON AVENUE, NEW YORK, NY, 10022-2585, US

(21) Appl. No.: 10/811,329

(22) Filed: Mar. 26, 2004

(30) Foreign Application Priority Data
Mar. 28, 2003 (JP) 2003-92941

(51) Int. Cl. H04L 12/28; H04L 12/56

(52) U.S. Cl. 370/401

(57) ABSTRACT

A Layer 2 switching device is provided, which includes: a flow table in which an entry is registered, the entry including an IP address of one host selected from first and second hosts as a source IP address thereof and MAC and IP addresses of the other host as MAC and destination IP addresses thereof; a converter that, in the case where data having the IP address of the one host set as the source IP address thereof and having the IP address of the other host set as the destination IP address thereof is received from the one host, converts the destination MAC address set in the data into the MAC address of the other host based on the entry in the flow table; and a unit that sends out the data, which has the destination MAC address converted, to the other host.

### BACKGROUND OF THE INVENTION

The present invention relates to a Layer 2 switching device which is connected to first and second hosts belonging to different LAN (Local Area Network) segments and connected to a router serving as a default gateway for the first and second hosts, and uses Layer 2 (namely, data link layer defined in the OSI reference model) for transferring data to be transferred between the first and second hosts.

For example, the present invention can be used in a communication environment where a so-called “hot standby system” is employed. In the hot standby system, two communication devices (routers) for performing routing based on an IP (internet protocol) are arranged, and the two routers are adapted to function logically as one router (virtual router) thereby attaining reliability and load sharing (balancing) of the routers. In such a communication environment, the present invention relates to a configuration (for example, a general LAN configuration such as seen at the center of a network) in which a plurality of hosts under a Layer 2 switch (an L2SW) and using a router of the hot standby system as their default gateway are divided into different LAN segments (broadcast segments=IP subnets), and can be applied to a technique for attaining high-speed communication between the hosts under the L2SW.

A VRRP (Virtual Router Redundancy Protocol: RFC 2338) that is an IETF Standard and a hot standby router system that is specific to each vendor (HSRP (Hot standby routing protocol) developed by Cisco Systems, Inc.) adopt a configuration as shown in, for example, FIG. 12. As exemplified in FIG. 12, two routers used in a hot standby configuration, one being set as active and the other being set as standby, are arranged as one virtual router. A host using the virtual router as its default gateway performs IP communication via the virtual router in the case of communicating with a segment different from a segment to which the host itself belongs.

WAN (Wide Area Network) lines configuring an IP network are becoming broadband. Thus, a mainstream system for servers to be the nerve center of the network is shifting from a distributed system used in a time when narrow band lines were adopted for the WAN lines to a centralized system in which servers are centrally collected in each server group at one or several centers. In the latter system, the server group consisting of several tens of servers is generally located at the center although the number depends on a scale of the network. Also, a large number of servers located at the center are divided into a plurality of segments depending on a security requirement or the like.

In the hot standby system, one LAN port of each server needs to be connected to the two routers, that is, an active router and a standby router as a virtual router in the hot standby configuration. Therefore, a configuration in which a hub is located between the server and the virtual router is usually adopted. FIG. 13 shows such a configuration.

Each server at the center performs high-speed communication with one another. Therefore, a high-speed interface (for example, a Gigabit Ethernet) is required. In this case, it is necessary to adopt such a configuration as shown in FIG. 14 or 15. In the configuration shown in FIG. 14, hosts (servers) in the same segment are accommodated in a hub (prepared for each segment). Each hub is connected through a LAN line to each of the active router and standby router configuring the virtual router. Alternatively, in FIG. 15, hosts (servers) divided into a plurality of segments are accommodated in an L2 switch (L2SW: a switching hub having VLAN functionality that allows segmentation on a LAN port basis) The L2SW is connected through a LAN line to each of the active router and the standby router configuring the virtual router on a segment basis. Note that the virtual routers shown in FIGS. 14 and 15 are connected to the WAN lines used in communication between each segment and each node in the network.

In addition, prior arts relating to the present invention include, for example, a remote access server disclosed in Patent Document 1.

The Patent Document 1 is Japanese laying-open application No. 2001-274843.

However, the prior arts shown in FIGS. 14 and 15 have the following problems.

Firstly, there is a problem with cost (over capacity) In either configuration shown in FIG. 14 or 15, in order to perform high-speed communication between segments, each hub or an L2SW and a virtual router need to have performance sufficient to provide a throughput of an entire bandwidth of LAN lines for respective servers accommodated therein.

In this case, the virtual router includes two routers and high-speed interfaces whose number corresponds to the number of the segments. For each router, an L3 switch (L3SW: IP switching router having functionality for hardware routing between a plurality of high-speed Ethernet interfaces), which is an expensive switching router capable of routing between those high-speed interfaces, must be adopted.

Here, if an L2SW accommodating a plurality of a high-speed LAN interfaces can be used to realize the communication between the segments, it is sufficient that the virtual router has a capability of IP-routing only communication data passing through the WAN lines. Accordingly, it becomes possible to select a WAN router corresponding to a bandwidth of the WAN lines, which is available at a reasonable price, allowing the reduction in over capacity.

However, in a hot standby router configuration (as shown in, for example, FIG. 15) based on a VRRP or the like, the default gateway for respective hosts (servers) connected to the L2SW is set to a virtual router across the L2SW. Thus, the communication between the respective segments connected to the L2SW is performed as follows. (1) Data is transferred from a source segment to the virtual router through L2 communication. (2) The virtual router uses an L3 routing (IP routing) process to route the data to a destination segment existing across the L2SW. Therefore, such a configuration cannot be attained as to make effective use of a high throughput of the L2SW to minimize the capabilities of the virtual router to the capability required for the WAN line communication.

Secondly, there is a problem with functionality of the virtual router. In addition to inter-server communication, each server at the center performs communication with each node in the network, which is connected through the WAN lines, by way of the virtual router. Differently from the LAN, the WAN lines have: a diversity of kinds of interface (As the WAN line interface, there are various kinds of interface such as an Ethernet (registered trademark), an ATM (Asynchronous Transfer Mode), a frame relay, an HSD (High Super Digital), and an ISDN (Integrated Services Digital Network).); and a diversity of functionality (The WAN lines provide lower speed than the LAN lines. Usually, carrier lines are used, so that functions different from those of the L3SW pursuing high-speed functions (including, for example, a shaping function based on each logical channel for the ATM or the frame relay, a data compression function that makes effective use of the low-speed lines, an encryption function for concealing data on the WAN line, a signaling function for the ISDN, and a fault detection function based on each kind of interface) are demanded in terms of restrictions on price).

The L3 switch can be provided with the WAN line interface. However, the L3 switch usually cannot flexibly support the functions required for controlling the WAN lines that have diversities as described above. Therefore, as shown in FIG. 16, a WAN line connection router is connected to each L3 switch composing the virtual router, and such a configuration is applicable as to have the WAN line connection router accommodate the diversities in the WAN lines.

### SUMMARY OF THE INVENTION

The present invention has an object to provide a Layer 2 switching device, which is capable of transferring data through communication between hosts belonging to different segments without passing the data through a router serving as a default gateway for the hosts.

In order to attain the above-mentioned object, the present invention employs a configuration described below.

That is, the present invention is a Layer 2 switching device which is connected to first and second hosts belonging to different LAN segments and to a router serving as a default gateway for the first and second hosts, including: a flow table in which an entry is registered, the entry including an IP address of one host selected from the first and second hosts as a source IP address thereof and MAC and IP addresses of the other host as destination MAC and IP addresses thereof; a converter that, in the case where data having the IP address of the one host set as the source IP address thereof and having the IP address of the other host set as the destination IP address thereof is received from the one host, converts the destination MAC address set in the data into the MAC address of the other host based on the entry in the flow table; and an unit that sends out the data, which has the destination MAC address converted, to the other host.

According to the present invention, through communication between the first and the second hosts, the data to be transferred from the one host to the other host can be transferred without being passed through the router.

Preferably, the Layer 2 switching device according to the present invention further includes a flow table learning unit that, in the case where data having the IP address of the one host selected from the first and second hosts set as the source IP address thereof and having the MAC and IP addresses of the other host set as the MAC and destination IP addresses thereof is received via the router and sent to the other host, creates the entry including the source IP address and the MAC and destination IP addresses which are set in the data to register the entry in the flow table.

With such a configuration, it is possible that the Layer 2 switching device spontaneously creates an entry in the flow table, and performs conversion and transfer processes for a MAC address as described above.

Preferably, the Layer 2 switching device according to the present invention further includes: an address table learning unit that, in the case where data to be transferred from the one host selected from the first and second hosts to the other host is received, registers an entry in an address table, the entry including a source MAC address and the destination IP address which are set in the data; and a flow table learning unit that: in the case where the data to be transferred from the one host to the other host is received via the router and sent to the other host, searches the address table by using the destination IP address in the data as a search key; and when the MAC address contained in a retrieved entry coincides with the destination MAC address in the data, creates an entry including the source IP address and the MAC and destination IP addresses which are set in the data to register the entry in the flow table.

With such a configuration, it is also possible that the Layer 2 switching device spontaneously creates an entry in the flow table, and performs conversion and transfer processes for a MAC address as described above.

Preferably, in the converter of the Layer 2 switching device according to the present invention, the source MAC address set in the data is converted into a MAC address of the router corresponding to the segment to which the other host belongs.

With such a configuration, the source MAC and destination addresses in data that reaches a host corresponding to a destination of the data has the same contents as in the case where the data passes through the router. Accordingly, the host can recognize the data that has arrived as having passed through the router.

Preferably, in the Layer 2 switching device according to the present invention, the flow table learning unit creates the entry for only each of ports to be connected to the first and second hosts.

With such a configuration, the entry is not created for ports to be connected to the router among a plurality of ports included in the switching device. Accordingly, the number of entries to be registered in the flow table can be suppressed.

Preferably, the Layer 2 switching device according to the present invention further includes a deletion unit that, in the case where a predetermined time has elapsed since an entry was newly registered or last updated in the flow table, deletes the entry.

With such a configuration, the entry is deleted every time the predetermined time elapses. Accordingly, in the case where the router controls filtering for inter-host communication, a change in conditions of the filtering can be promptly reflected on the flow table.

Preferably, in the Layer 2 switching device according to the present invention, of the data to be transferred from the one host selected from the first and second hosts to the other host, a particular kind of data is not subjected to a process performed by the converter, and transferred to the router.

According to such a configuration, of the data to be transferred between the first and second hosts, a kind of data that is preferable to pass through the router can be transferred to the router.

Further, the present invention can be specified as a data exchange method using the converter of the Layer 2 switching device having the above-mentioned features.

### BRIEF DESCRIPTION OF THE DRAWINGS

Other aspects and/or advantages of the present invention will become apparent during the following discussion in conjunction with the accompanying drawings, in which:

FIG. 1 is a diagram showing a configuration example of a system implemented according to the present invention;

FIG. 2 is a diagram showing an example of communication between segments via an L2 switch;

FIG. 3 is a diagram showing an example of communication performed by an inter-segment exchange process using the L2 switch;

FIG. 4 is a table (Table 1) showing characteristics of data involved in communication between segments under the L2 switch;

FIG. 5 is a diagram showing an example of a data structure of an address table;

FIG. 6 is a flowchart showing an address table learning process;

FIG. 7 is a diagram showing an example of a data structure of a flow table;

FIG. 8 is a flowchart showing a flow table learning process;

FIG. 9 is a flowchart showing the inter-segment exchange process under the L2 switch;

FIG. 10 is a diagram showing a configuration example of the L2 switch;

FIG. 11 is a sequence diagram showing the inter-segment exchange process under the L2 switch shown in FIG. 3;

FIG. 12 is a diagram showing a configuration example of a virtual router;

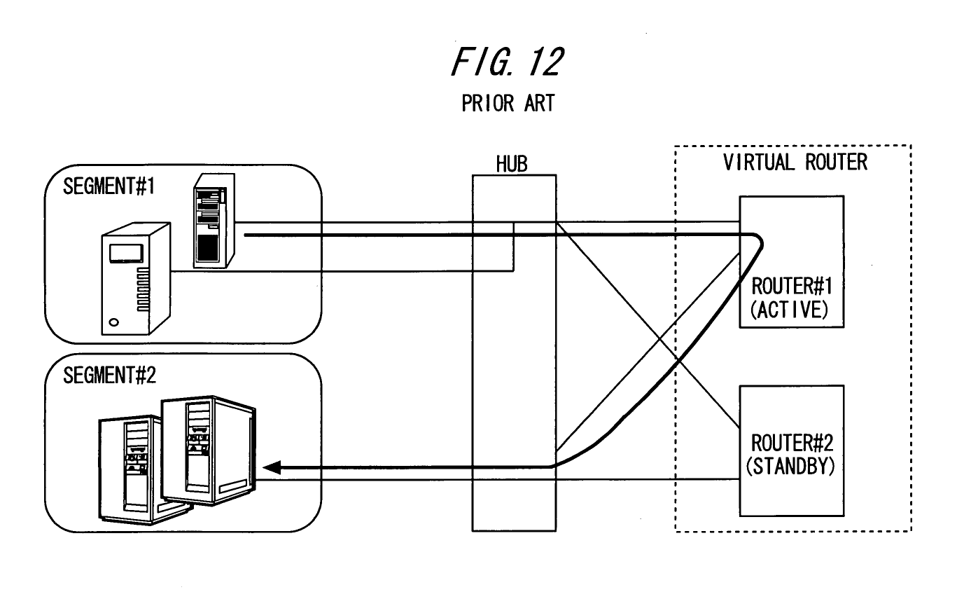

FIG. 13 is a diagram showing a configuration example of how a host is connected to the virtual router;

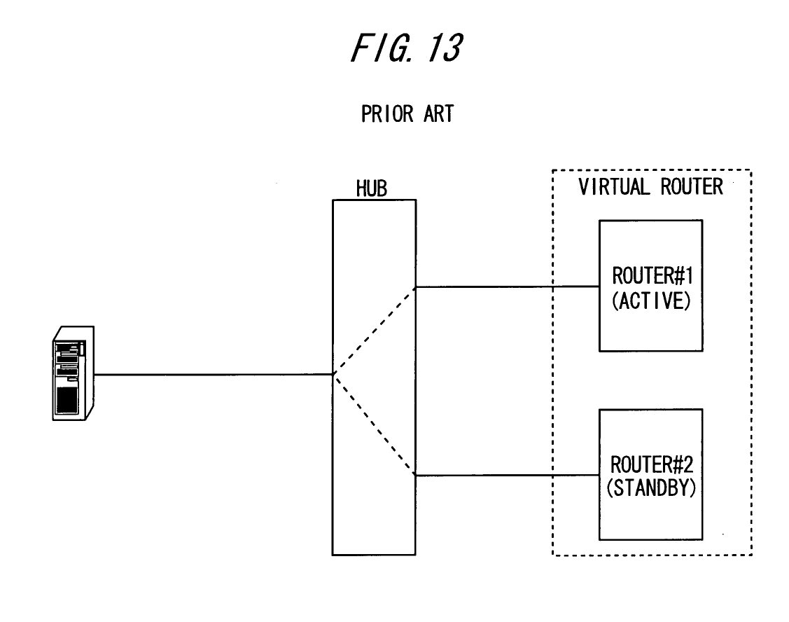

FIG. 14 is a diagram showing a configuration example of how each host is connected to the virtual router through a hub on a segment basis;

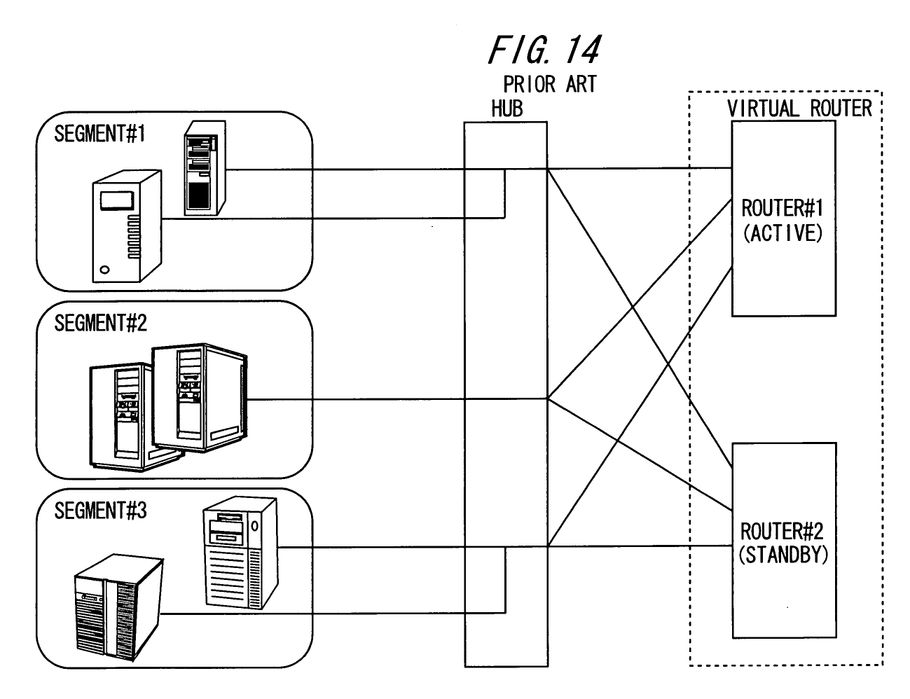

FIG. 15 is a diagram showing a configuration example of how each host is connected to the virtual router through an L2 switch for accommodating a plurality of segments to which each host belongs; and

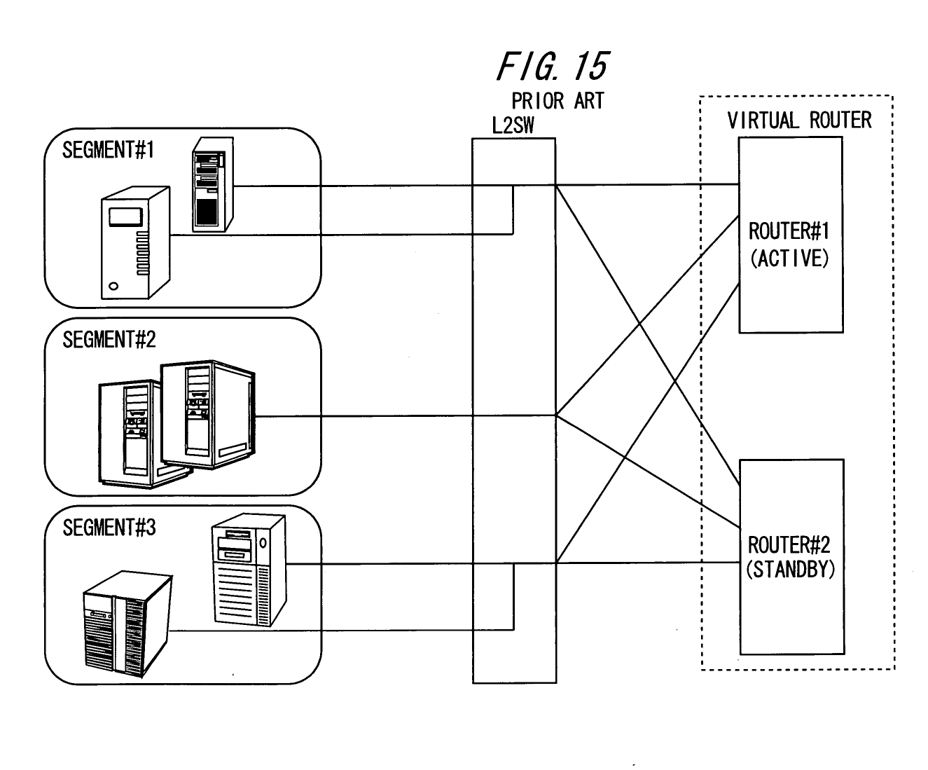

FIG. 16 is a diagram showing a configuration example of connection with WAN lines.

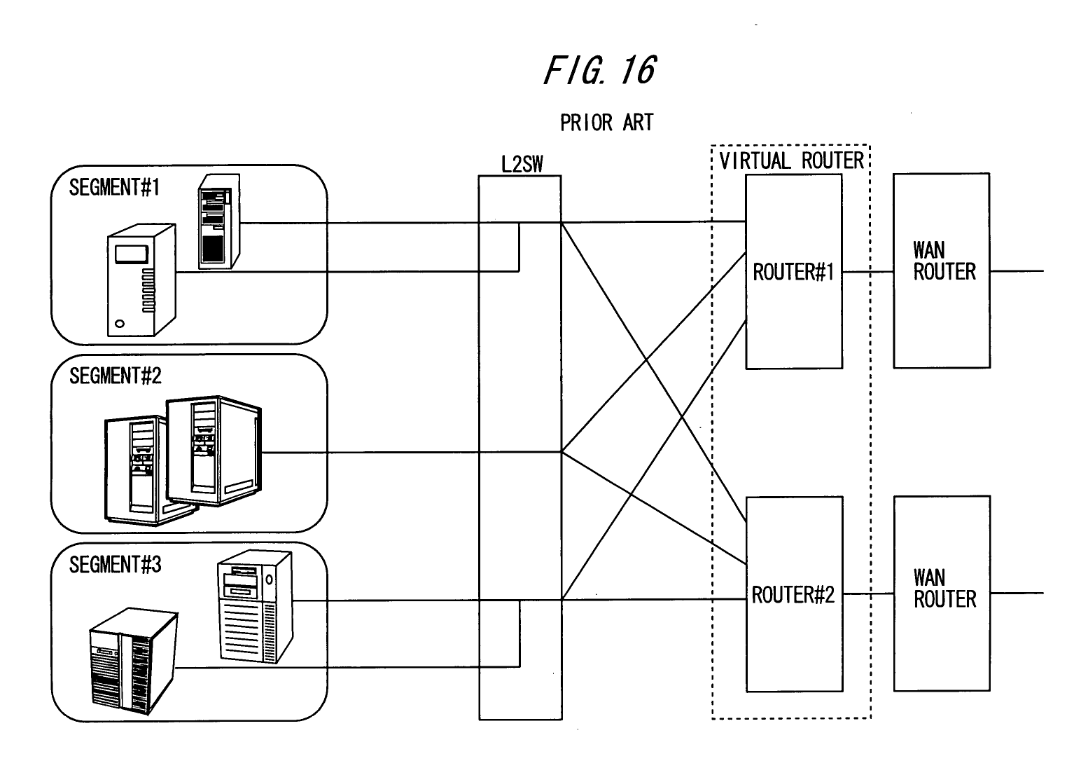

### DESCRIPRION OF THE PREFERRED EMBODIMENTS

[Outline of the Invention]

A Layer 2 switching device (which may sometimes be represented as “L2SW”) according to the present invention can be applied to, for example, a network configured such that a plurality of hosts are connected through the L2SW to a WAN router (virtual router) having a redundant configuration based on a hot standby protocol such as a VRRP.

In the case where the plurality of hosts are divided into a plurality of segments (subnets), the L2SW performs switching using normal LAN switching functionality between the hosts within the same subnet. On the other hand, for communication between the hosts belonging to different segments, the L2SW first allows the communication to be performed via the virtual router, and can simultaneously learn characteristics of a flow between the hosts via the virtual router. Contents to be learned are, for example, a relationship among a LAN line (port) of the L2SW, a MAC (Media Access Control) address, and an IP address. Results from the learning can be stored as a flow table.

Then, when the L2SW receives data from a host, the flow table is searched. In the case where a flow having the same characteristics as those of a data flow via the virtual router is found, the L2SW exchanges an address indicating portion (destination MAC address) of a header of a data packet, which is to be sent to the virtual router, for an address indicating portion stored in the flow table, which is to be sent from the router to a destination host. After that, the L2SW transfers the data packet to a send queue of a destination port for the data.

Therefore, the communication between the hosts belonging to different segments under the L2SW can be performed as direct communication by an exchange process at the L2SW without passing the data through the router. Accordingly, the large-capacity communication between the hosts in a local segment is performed by the exchange process at the L2SW, and the WAN router of a hot standby system can be set as a reasonably priced router capable of providing a throughput of a bandwidth of WAN lines, allowing a reduction in over capacity and optimization of cost.

Further, the present invention can be configured, for example, to have a mechanism for resetting an entry in the flow table after a predetermined period so as not to allow the exchange process between the different segments at the L2SW to last for a long period of time. Accordingly, a change in filtering conditions (based on, for example, security conditions) for the communication between the hosts controlled by the router (for example, virtual router) can be promptly reflected on the flow table.

The filtering conditions (to block or pass) based on an IP address are usually set in the router. In the L2SW according to the present invention, a first inter-host communication (transfer of the data between the hosts for the first time) can be performed via the router. Therefore, the L2SW learns a data flow satisfying the filtering conditions set in the router, and the exchange process at the L2SW can be performed. The contents to be learned at this time can reflect the filtering conditions set in the router.

However, if the results from the learning of the flow are continuously held, the change in filtering conditions made on a router side cannot be reflected on the inter-host communication. By an aging function of the above-mentioned flow table, the filtering conditions on the router side can be reflected in a short period.

Further, according to the present invention, a granularity can be improved in the case of inter-host communication between different segments with a finer-grain L2SW by, for example, adding identification of each flow to an IP header portion other than addresses. For example, in the case where a protocol field of an IP header of a packet received from the host indicates “1”, the data is not subjected to the exchange process at the L2SW, but subjected to a normal L2 process. Accordingly, the present invention can be configured such that an ICMP (Internet Control Message Protocol) packet to be transferred between the hosts is not shortcut at the L2SW but sent to the virtual router as in a normal case.

[Embodiments]

Hereinafter, description will be made of an embodiment mode of the present invention with reference to the drawings. The embodiment mode described below is merely an example of the present invention, and the present invention is not limited to the configuration of the embodiment mode.

<Outline of the Embodiment Mode>

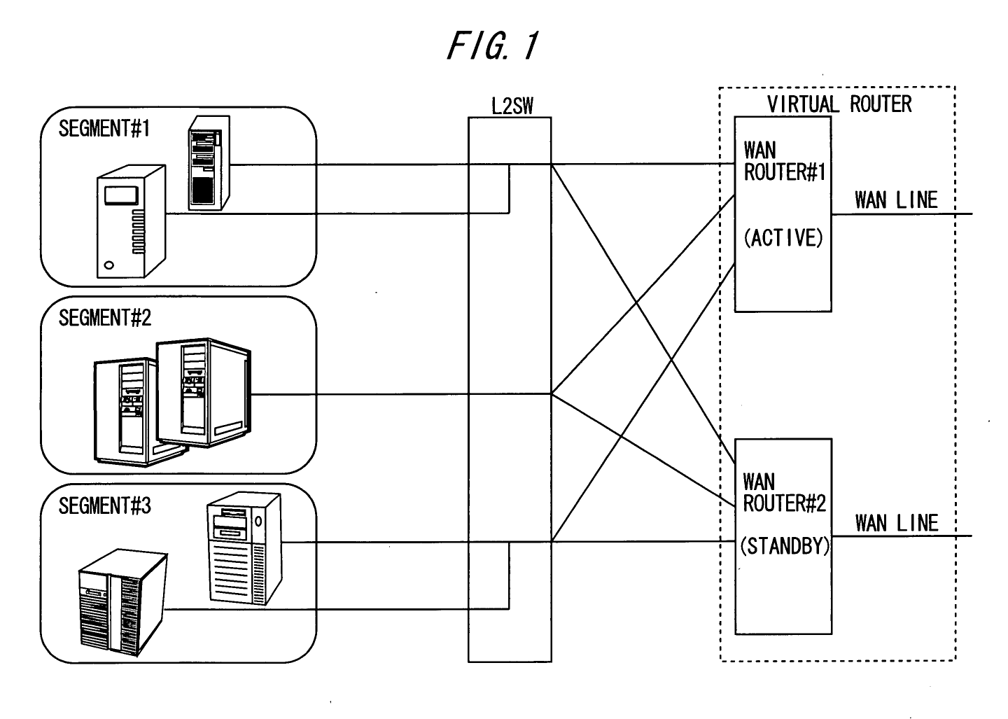

According to the embodiment mode of the present invention, as shown in FIG. 1, instead of using expensive L3 switches, inexpensive two WAN routers having hot standby functionality are used to attain virtual router functionality, and a technique for achieving high-speed LAN communication between segments is provided. Accordingly, the problems with the prior art can be solved.

Such a system as shown in FIG. 1 can employ, as a default gateway for each host within each segment, a virtual router composed of WAN routers that can execute routing and forwarding to such an extent as to allow a throughput equivalent to that of WAN lines. In addition, communication between hosts within the same segment and communication between hosts within different segments are performed using the L2 switch having functions according to the present invention as high-speed communications with the throughput of the L2SW.

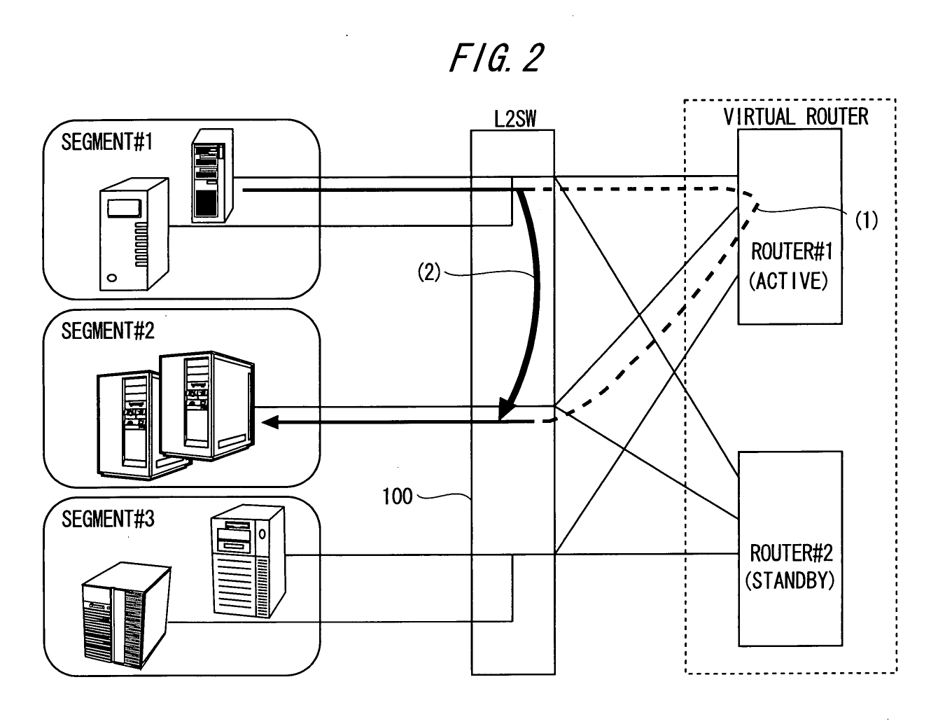

Accordingly, this embodiment mode employs, for example, such a system configuration as shown in FIG. 2. In the system configuration exemplified in FIG. 2, an L2 switch (which may sometimes be represented as “L2SW”) 100 that accommodates a plurality of LAN segments (in FIG. 2, segments #1 to #3 divided in a VLAN) is prepared. Each segment includes one or more hosts (servers).

Also, in the above system, a virtual router composed of two routers (router #1 (active) and router #2 (standby)) having the hot standby functionality is prepared. The L2 switch 100 is composed of a set of LAN lines prepared for each segment, and connected to the respective routers #1 and #2 composing the virtual router. With this arrangement, the respective hosts in each segment are configured with the virtual router being set as the default gateway.

The default gateway represents a device having an IP address that is specified as a destination IP address by a source host in the case where IP packets are sent/received between the hosts belonging to different segments.

As a function according to the present invention, the L2 switch 100 has a function for performing the exchange process between the segments thereunder. According to the function, through communication between the hosts belonging to different segments under the L2 switch 100, communication data to be sent/received between the hosts are transferred without being subjected to an L3 routing process at the virtual router corresponding to the default gateway for those hosts (without being passed through the router).

That is, as shown in FIG. 2, in an example case where data is sent from a host of the segment #1 to a host of the segment #2, the L2 switch 100 does not pass the data from the segment #1 to the router #1 ((1) of FIG. 2), but instead transits the data to a traffic flow to the segment #2 within the L2 switch 100 ((2) of FIG. 2). Hereinafter, description will be made of a configuration for attaining the above-mentioned L2 switch 100.

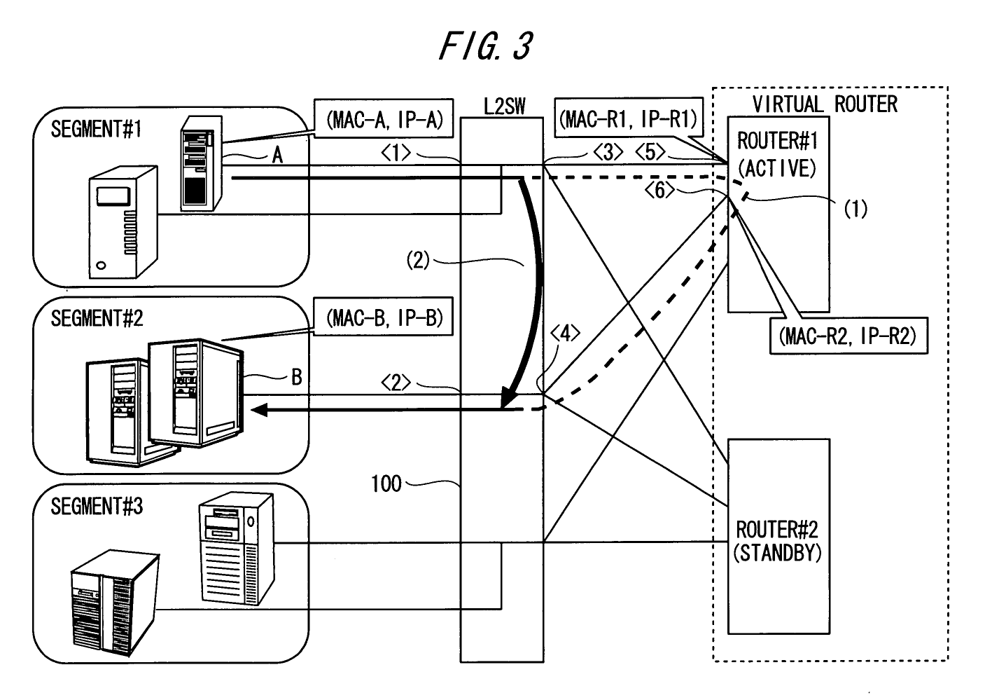

FIG. 3 shows a case where, in the system configuration as shown in FIG. 2, data communication is performed between a host A (MAC address: MAC-A, IP address: IP-A) belonging to the segment #1 and a host B (MAC address: MAC-B, IP address: IP-B) belonging to the segment #2. The respective segments #1 to #3 shown in FIG. 3 have different VLAN-IDs set as their segment identifiers.

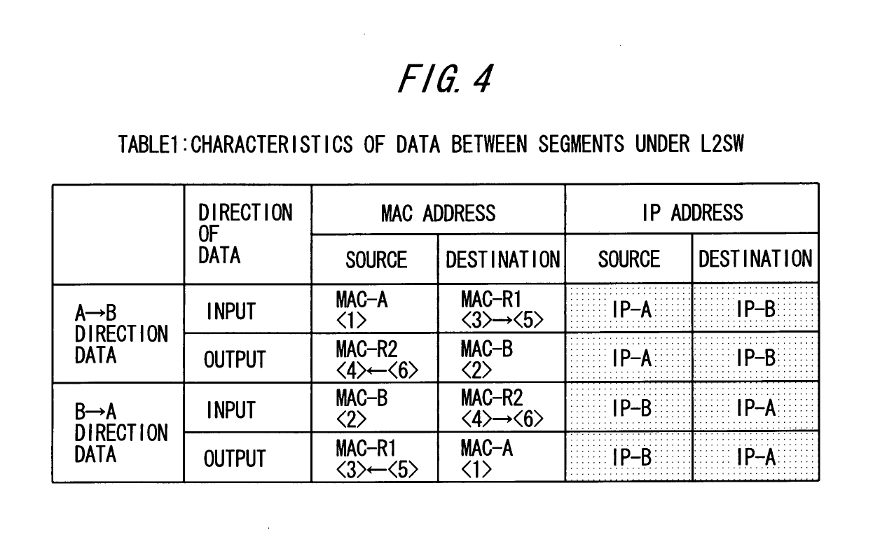

In an example shown in FIG. 3, in the case where traffic passes through the virtual router (a conventional transfer path: (1) of FIG. 2) in the communication between the hosts belonging to different segments, communication data to be transferred, for example, between the host A of the segment #1 and the host B of the segment #2 through the virtual router is represented by Table 1 of FIG. 4.

By receiving data (a MAC frame) from each LAN line (receiving port) accommodated by the L2 switch itself, the L2 switch learns correspondence between a source MAC address in the received data (MAC frame) and a port number, and registers the correspondence in a not-shown MAC address table (mapping table) (a MAC address learning function).

Then, in the communication between the hosts belonging to the same segment (VLAN), a destination port number corresponding to a destination MAC address (MAC address of a destination host) added to data sent from a source host is retrieved from the mapping table to obtain an output port, and the data is outputted to the port. Accordingly, the L2 switch transfers the data to be communicated between hosts within the same segment from a source host to a destination host.

Here, in the case where the source host and the destination host belong to different segments (for example, source: the host A, destination: the host B), a combination of a source MAC address (MAC SA) and a destination MAC address (MAC DA) that are set in data sent from the source host is not a combination of respective MAC addresses of the source host and the destination host (MAC address of the host A and MAC address of the host B), but a combination of the MAC addresses of the source host and its default gateway.

For example, the source MAC and destination addresses set in the data to be transferred from the host A to the host B are a MAC address (MAC-A) of the host A and a MAC address (MAC-R1) corresponding to the segment #1 of the virtual router (router #1) serving as the default gateway for the host A.

On the other hand, the source MAC and destination addresses set in the data to be transferred from the host B to the host A are a MAC address (MAC-B) of the host B and a MAC address (MAC-R2) corresponding to the segment #2 of the virtual router (router #1) serving as the default gateway for the host B.

Further, as to IP address according to the above-mentioned communication, a combination of IP addresses of the host A and the host B is used either in the same segment or between different segments. This characteristic can be observed in Table 1. Note that in such communication, the L2 switch does not refer to the IP address in data.

In the above-mentioned communication examples, in the case where data is sent from the host A to the host B, the following operation is performed.

(1) The host A sends data (MAC SA: MAC-A, MAC DA: MAC-R1, source IP address (IP-SA): IP-A, destination IP address (IP DA): IP-B) whose destination is the host B to the L2 switch.

(2) The L2 switch receives data at a port <1>, and transfers the data from the port (3) to the router #1 based on the mapping table.

(3) The router #1 identifies MAC-B from the data with the IP DA being IP-B, sets MAC-B as the MAC DA of the data, and routes the data to a corresponding port <6>.

(4) The L2 switch receives data at a port <4>, and transfers the data from the port <2> to the segment #2 (host B) based on the mapping table.

On the other hand, in the case of transferring data from the host B to the host A, the above operation is performed in the reverse order.

<Address Table Learning>

Meanwhile, the L2 switch 100 according to the present invention utilizes the characteristics of addresses set in the data (header of a data packet) shown in FIG. 4. That is, the L2 switch 100 learns the source MAC address (MAC SA) of the data received from a port, and simultaneously learns the source IP address (IP SA) to store the addresses in a table. The table thus prepared is called “address table”. The address table has a data structure functioning as a mapping table for ports, source MAC addresses (MAC SAs), and source IP addresses (IP SAs). In addition, the address table can be structured so as to allow a time stamp, which indicates the time when an entry is registered or updated, to be recorded for each entry.

In the L2 switch 100, it can be set for each port included in the L2 switch 100 whether the source IP address is learned or not. For example, regarding connection ports (the ports <3> and <4> in the example of FIG. 3) with respect to the virtual router, the L2 switch 100 can be set so as not to learn the source IP address in received data. Such a setting is effected by, for example, an operation of an administrator of the L2 switch 100 to statically set a flag, which indicates whether the learning of the IP SA is executed or not, in the L2 switch 100 for each port.

Note that instead of the static data setting described above, the L2 switch 100 may also be provided with an appropriate algorithm (program) to have such a configuration as to automatically set an operation in which the IP address learning is not performed at virtual router connection ports.

Therefore, by limiting ports for learning source IP addresses to host connection ports, the number of entries to be learned (registered) in the address table equals the number of the addresses of hosts connected directly to the L2 switch 100. Accordingly, the number of entries in the address table can be restrained from increasing due to the learning of the IP addresses of the hosts in the entire network existing across the virtual router.

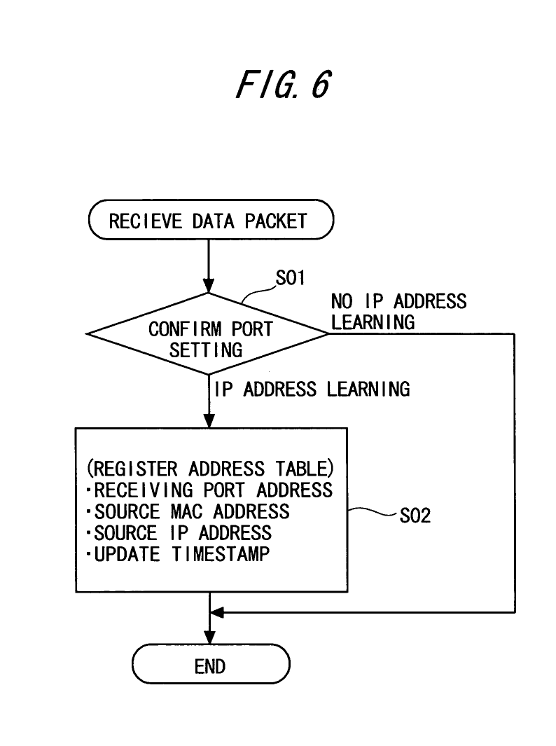

FIG. 6 is a flowchart showing a learning process flow for an address table 8 by the L2 switch 100. As shown in FIG. 6, upon receiving data (a data packet) from a given port, the L2 switch 100 judges whether the L2 switch 100 is set to learn the IP address in the data from the port or not (whether the flag for the IP address learning is on or not) (S01).

At this time, in the case of being set to learn the IP address (S01; IP address learning), the L2 switch performs an address table registering process. That is, the L2 switch 100 obtains a port number of a port from which the data packet is received, obtains the source MAC address (MAC SA) and the source IP address (IP SA) from the data packet as well, registers the port number, source MAC address, and the source IP address in the address table 8, and registers or updates the time stamp of the entry (S02). Then, the L2 switch 100 ends the learning process.

On the other hand, in the case of being set not to learn the IP address (S01; no IP address learning), the L2 switch 100 ends the learning process.

<Flow Table Learning>

In addition, the L2 switch 100 performs a flow table learning process. For example, in the case of sending data to each port, the L2 switch 100 searches the address table 8 by using the destination IP address in a data packet to be sent as a search key. At this time, in the case where the corresponding entry is hit, the L2 switch 100 judges whether the MAC address (MAC SA) of the entry is identical to the destination MAC address (MAC DA) of the data packet.

At this time, in the case where the source MAC address coincides with the destination MAC address, the L2 switch 100 learns (creates an entry including) a combination of the source MAC address, the destination MAC address, the source IP address, and the destination IP address in association with a sending port number, and stores the entry in a table. The table in which an entry is thus registered is called “flow table”.

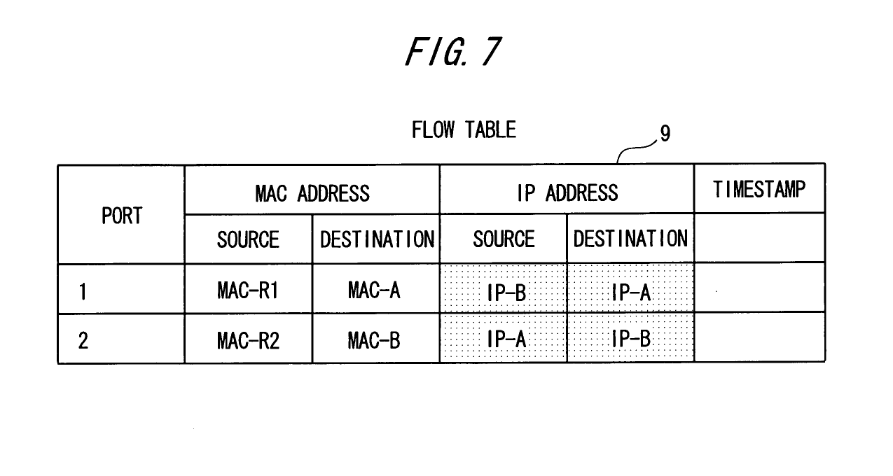

FIG. 7 is a diagram showing a data structure in a flow table. A flow table 9 shown in FIG. 7 stores an entry, which contains a sending port number, a source MAC address, a destination MAC address, a source IP address, and a destination IP address, and a time stamp indicating the time when the entry is registered or updated, for each port for which the IP address learning is set.

The L2 switch 100 refers to the flow table 9 as shown in FIG. 7, and can therefore discriminate the port, the source MAC address, the destination MAC address, the source IP address, and the destination IP address for the data packet to be sent.

Note that in the configuration based on the flow table described above, the learning of the flow table is not performed for the port connected to the router. This is because the learning of the source IP address is not performed for the router connection port as described above, so that upon searching the address table 8 using the destination IP address in the data packet, the router connection port is not hit.

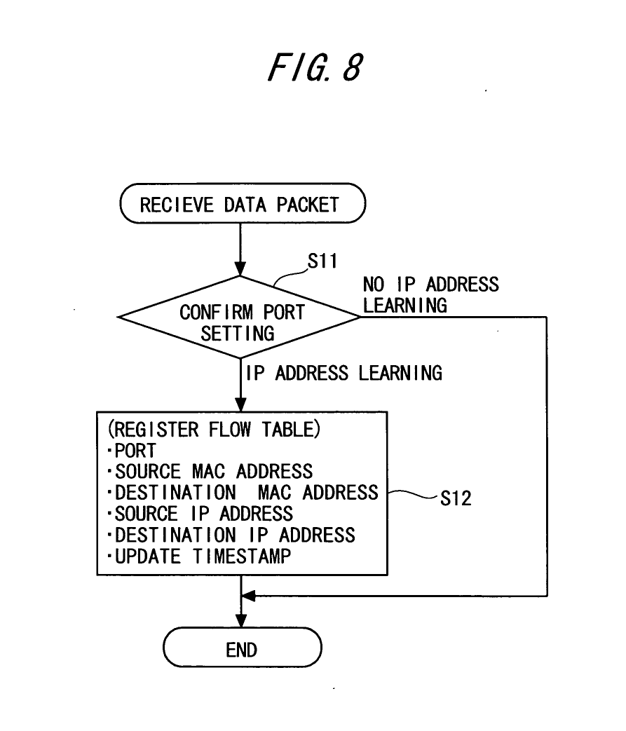

Instead of the above configuration, such a configuration as shown in FIG. 8 can be adopted. FIG. 8 is a flowchart showing a flow of a learning process of the flow table 9 by the L2 switch 100. As shown in FIG. 8, upon receiving a data packet, the L2 switch 100 judges whether the IP address learning is set for the sending port of the data packet or not (S11).

At this time, in the case of being set to learn the IP address (S11; IP address learning), the L2 switch 100 performs the flow table registering process in S12 that follows. That is, the L2 switch 100 obtains a port number of a port to which the data packet is sent, obtains the source MAC address, the destination MAC address, the source IP address, and the destination IP address from the data packet as well, and registers the addresses in the flow table 9 together with the time stamp. Then, the L2 switch 100 ends the flow. On the other hand, in the case of being set not to learn the IP address (S11; no IP address learning), the L2 switch 100 ends the flow.

As described above, in creation of the flow table, similarly to the address table learning, the L2 switch 100 may also employ a configuration in which the flow table learning process upon outputting a data packet is not performed for the router connection port.

<Inter-segment Exchange Process under L2 Switch>

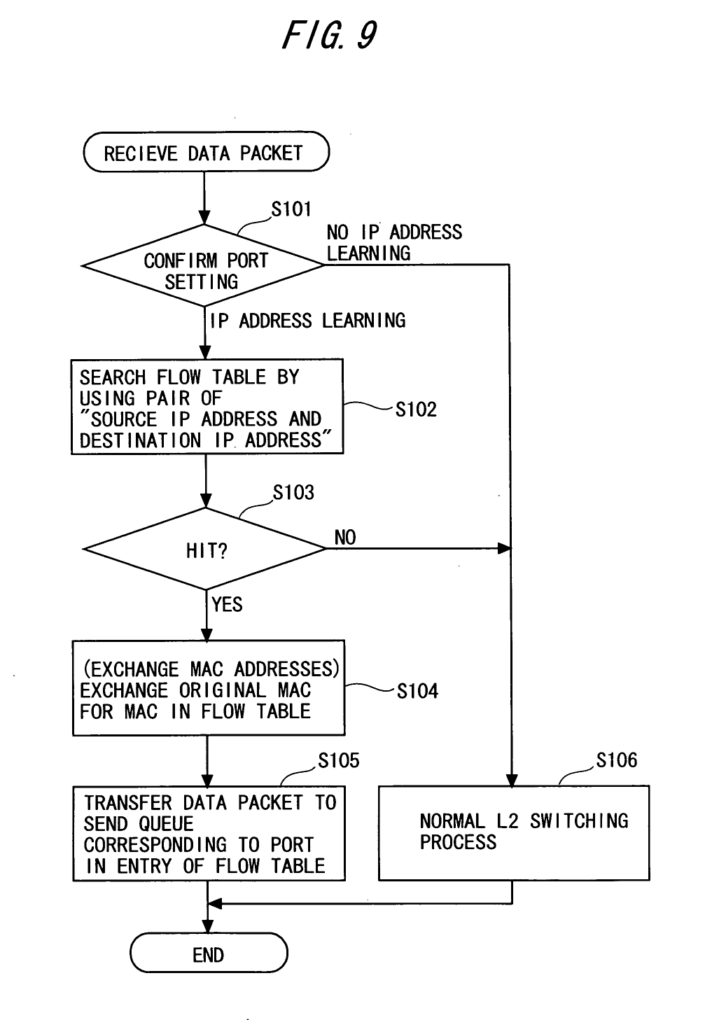

Subsequently, the L2 switch 100 performs such a process as shown in FIG. 9 on a data packet received from each port. FIG. 9 is a flowchart showing a flow of an “exchange” process relating to data communication between segments under an L2 switch.

In FIG. 9, upon receiving a data packet from a given port, the L2 switch 100 judges whether the L2 switch 100 is set to learn the IP address for the port or not (S101) At this time, in the case of being set to learn the IP address (S101; IP address learning), the process advances to S102. Otherwise (S101; no IP address learning), the process advances to S106.

In S102, the L2 switch 100 searches the flow table 9 by using a pair of the source IP address and destination IP address that are set in the data packet, and judges whether there is an entry including the pair or not (S103).

At this time, the entry including the pair of the identical source and destination IP addresses is hit (S103; YES), the process advances to S104. Otherwise (S103; NO), the process advances to S106.

In S104, the L2 switch 100 performs the subsequent MAC address exchange process. That is, the L2 switch 100 “exchanges” a pair of MAC addresses in the data packet (the source MAC address and the destination MAC address that are set in the data packet when received) for a pair of the source MAC address and the destination MAC address that are stored in the hit entry.

Then, the L2 switch 100 transfers the data packet to the send queue corresponding to the port number stored in the hit entry (S105), and ends the flow. As a technique for implementing hardware and software for a data switch between ports, any existing technique can be applied.

Alternatively, in the case where the process advances to S106, the L2 switch 100 executes the normal L2 switching process, and then ends the flow.

<Configuration Example of L2 Switch>

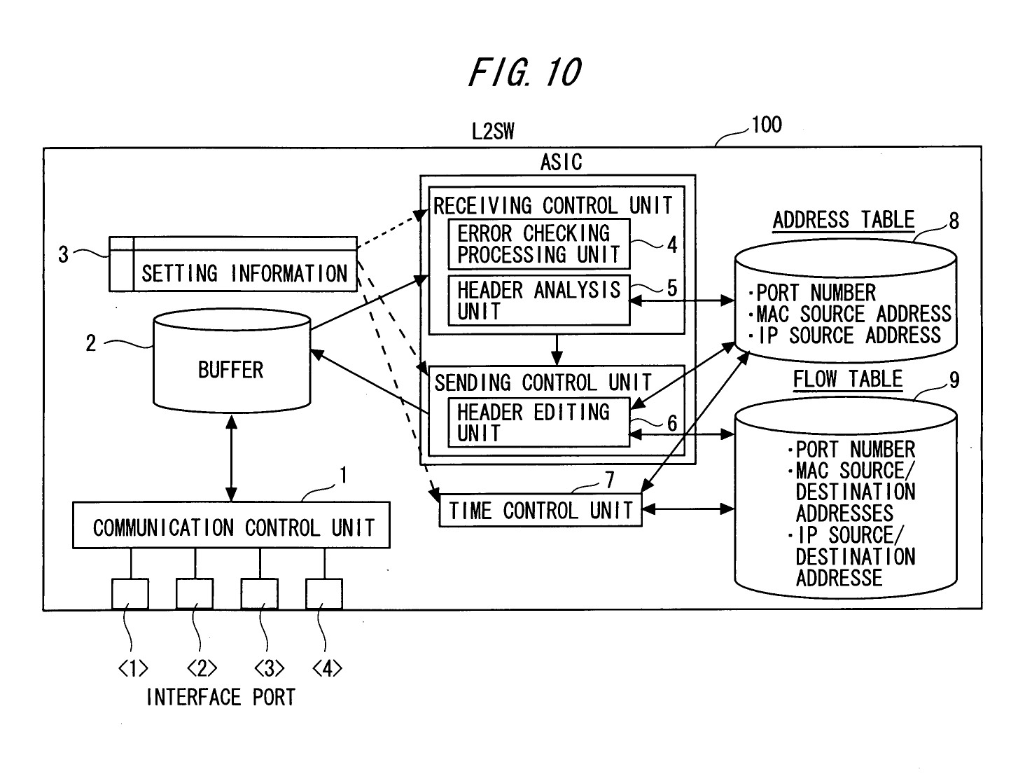

FIG. 10 is a diagram showing a configuration example of the L2 switch 100 having the above-mentioned functionality. In the example shown in FIG. 10, the L2 switch 100 includes interface ports <1> to <4>, a communication control unit 1, a buffer 2, a setting information storage area 3, an ASIC (Application Specific Integrated Circuit), a time control unit 7, an address table 8, and a flow table 9. The ASIC has a receiving control unit and a sending control unit, the receiving control unit including an error checking processing unit 4 and a header analysis unit 5, the sending control unit including a header editing unit 6. The respective tables 8 and 9 are stored in a storage device within the L2 switch 100.

Here, the communication control unit 1 performs control of transmitting/receiving of packets on a port basis and collection of address information. The buffer 2 is used as a storage area for received packets and packets to be sent. The setting information storage area 3 is a storage area for user setting values, and stores presence/absence (execution/non-execution) of the IP address learning, a setting value for a timer (a predetermined period of time to be required for deletion of an entry), and the like which are set by a user (an administrator of the L2SW). The communication control unit 1 functions as a unit that sends out data according to the present invention.

The error checking processing unit 4 performs error checking on a received packet. Based on the setting information (a flag indicating the presence/absence of the IP address learning for each port) stored in the setting information storage area 3, the header analysis unit 5 performs a comparison process between header information of the data packet and the address table 8, and an updating process for the address table 8 based on the comparison results. The above-mentioned address table learning process (FIG. 6) is performed at the header analysis unit 5. The header analysis unit 5 functions as an address table learning unit according to the present invention.

Based on the setting information (the flag indicating the presence/absence of the IP address learning for each port) stored in the setting information storage area 3, the header editing unit 6 performs a comparison process for the header information with the address table 8 and the flow table 9. Then, the header editing unit 6 performs reediting of the header information, and an adding and updating processes for the entry in the flow table 9 based on the comparison results. The above-mentioned flow table learning process (FIG. 8) and the inter-segment exchange process (FIG. 9) are performed at the header editing unit 6. The header editing unit 6 thus functions as a converter and a flow table learning unit according to the present invention.

The time control unit 7 performs updating of a time stamp for each entry registered in each of the tables 8 and 9, and a deletion process (aging process: which will be described later) for the entry. The time control unit 7 functions as a deletion unit according to the present invention.

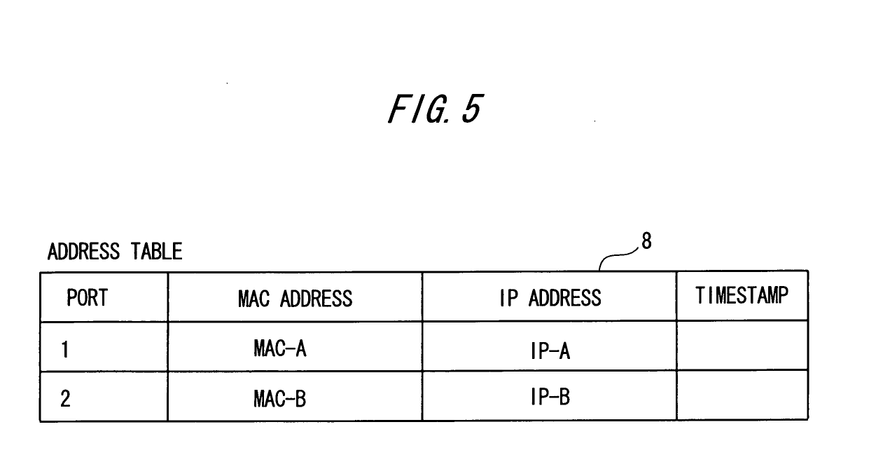

The address table 8 has the data structure as shown in FIG. 5, and is used as a storage area for the address information of the received packets. The flow table 9 has the data structure as shown in FIG. 7, and is used as a storage area for information on paths used as shortcuts for the inter-segment communication.

<Operation Example>

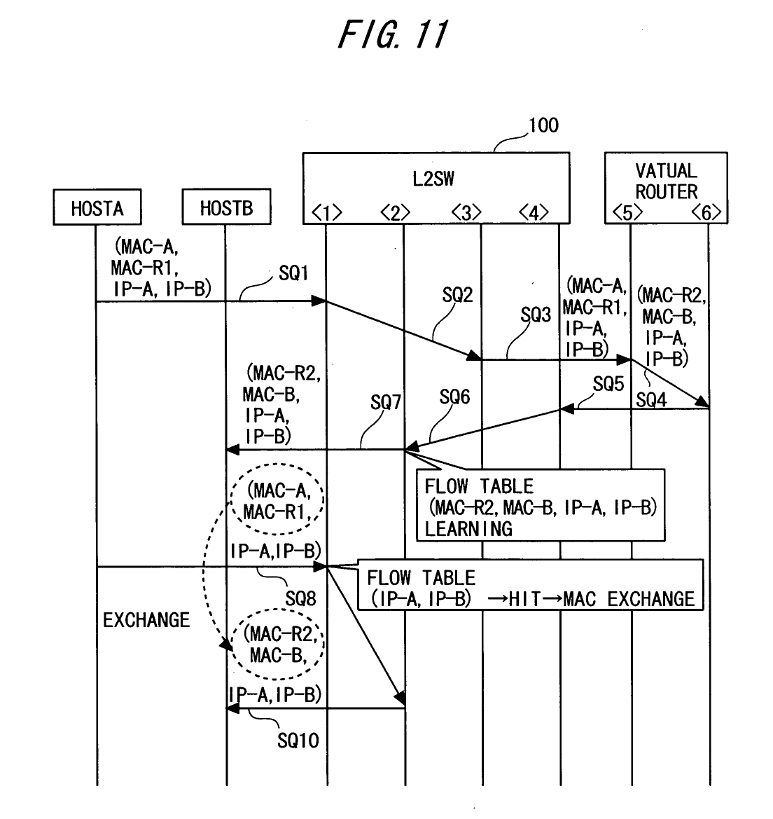

FIG. 11 is a sequence diagram showing a case where, in the communication between the host A and the host B shown in FIG. 3, the L2 switch performs the exchange process according to the present invention on data to be transferred from the host A to the host B. In the sequence shown in FIG. 11, the L2 switch 100 is set to learn the IP addresses for the ports <1> and <2>. In addition, at the start of the sequence of FIG. 11, the L2 switch 100 has learned a correspondence between the respective ports and the destination MAC addresses by, for example, a normal MAC address learning. Thus, data packets (MAC frames) received from the respective ports can be sent out from appropriate output ports based on the destination MAC addresses contained therein.

In FIG. 11, in the case where the host A belonging to the segment #1 is to send data to the host B belonging to the segment #2, the host A sends to the L2 switch 100 a data packet having a header in which a source MAC address “MAC-A”, a destination MAC address “MAC-R1”, a source IP address “IP-A”, and a destination IP address “IP-B” are set (FIG. 11; SQ1).

The L2 switch 100 receives the data packet from the port <1> and sends out the data packet from the port <3> to the virtual router. (FIG. 11; SQ2 and SQ3).

The virtual router (router #1) receives the data packet from the port <5>, performs IP routing, converts the destination MAC address in the data packet into a MAC address “MAC-B” of the host B, and sends out the data packet from the port <6> to the L2 switch 100 (FIG. 11; SQ4 and SQ5).

The L2 switch 100 receives from the port <4> the data packet sent from the virtual router, and sends out the data packet from the port <2> to the host B (FIG. 11; SQ6 and SQ7). At this time, based on the header information of the data packet, the header editing unit 6 of the L2 switch 100 creates and registers an entry according to the port <2> as shown in FIG. 7 in the flow table 9.

After that, when another data packet to be sent to the host B is sent out from the host A, the L2 switch 100 receives the data packet from the port <1> (FIG. 11; SQ8).

Further, the header editing unit 6 of the L2 switch 100 refers to the flow table 9 to perform the exchange process shown in FIG. 7. That is, the header editing unit 6 searches the flow table 9 by using a pair of the source IP address “IP-A” and the destination IP address “IP-B” in the data packet. At this time, the entry according to the port <2> is hit. Then, the header editing unit 6 converts (exchanges) the pair of the source MAC address “MAC-A” and the destination MAC address “MAC-R1” that are set in the data packet into (for) the pair of the MAC addresses (the source MAC address “MAC-R2” and the destination MAC address “MAC-B”) in the entry. After that, the data packet is transferred to the send queue of the port <2>, and sent out from the port <2> to the host B (FIG. 11; SQ9 and SQ10).

Further, in the case where the data packet is transferred from the host B to the host A, the same operation is performed as in the sequence shown in FIG. 11. That is, upon sending the data packet for the first time, in the case where the L2 switch 100 sends from the port <1> the data packet from the virtual router, an entry according to the port <1> is registered in the flow table 9. After that, upon sending the data packet for the second time, an entry according to the port <2> is registered in the address table 8. Simultaneously, the MAC addresses are exchanged based on the entry according to the port <1> in the flow table 9. As a result, the data packet is sent out from the port <1> to the host A without being transferred to the virtual router.

Note that in the above-mentioned operation example, without using the address table 8, the L2 switch 100 performs the exchange process by the learning process for the flow table 9 based on the setting “on” of the IP address learning. On the other hand, the header analysis unit 5 of the L2 switch 100 can perform the address table learning process according to the port <1> based on the header information of the data packet (the source MAC address “MAC-A” and the source IP address “IP-A”). The address table learning process according to the port <1> can be performed at both times of receiving the data packet from the host A. In this case, upon receiving the data packet to be transferred from the host B to the host A via the virtual router, the header editing unit 6 can perform the flow table learning process based on an entry according to the port <1> in the address table 8.

By the above-mentioned operation, the data packet to be transferred between the host A and the host B passes through the virtual router for the first time. However, for the second time and later, the data packet is shortcut by the L2 switch 100 to reach the destination host without being passed through the virtual router.

Therefore, in the communication between the hosts belonging to different segments, the virtual router has only to bear a load of routing and forwarding relating to the transfer process for the data packet for the first time. Accordingly, the virtual router can have its own capabilities focused on processes relating to the WAN lines that connect each host and the nodes in the network. As a result, as the router composing the virtual router, the WAN router suitable for the WAN configuration can be applied instead of the L3 switch.

Meanwhile, the L2 switch 100 can transfer not only the data between the hosts belonging to the same segment but also the data between the hosts belonging to different segments to the destination segment by the switching process within the L2 switch 100 (without passing the data through the router) The transfer process at this time can employ a high-speed switching function at the L2, which is provided to the L2 switch 100. Accordingly, the data packet can be transferred between the hosts at higher speed than in the case of passing the data through the virtual router.

Further, each host in each segment receives data including the same address information as in the case of passing the data through the virtual router serving as a default gateway. Thus, each host recognizes that the data is transferred via the default gateway. Therefore, when adopting the configuration of the embodiment mode, it is unnecessary to change the configuration of the host. In this case, the configuration easily allows additional execution of a process for causing the contents of the header information, which is to be received by a destination host, to be equal to that in the case of passing the data through the virtual router, such as a subtraction process for TTL (Time To Live) of a header.

<Aging Process>

Further, a time stamp set for each entry in the tables 8 and 9 is applied to the aging process performed by the time control unit 7. The time control unit 7 includes a timer for the aging process, and is capable of executing the aging process for an entry as described below based on a timer value set in the setting information storage area 3.

As a first configuration, when the L2 switch 100 receives/sends a data packet, every time an entry is registered in the table 8 and/or 9, the time control unit 7 updates a value of the time stamp for the entry to the current time.

Here, the time control unit 7 performs precise examination on each of the tables 8 and 9 on a regular basis. In the case where an entry whose registered time (time stamp value) exceeds a predetermined time period (registered in the setting information storage area 3) exists, the time control unit 7 deletes the entry. Therefore, in the case where the entry is unused for a predetermined time period, an operation to temporarily cancel the exchange process for MAC addresses can be performed.

As a second configuration, the time control unit 7 registers the time when a new entry is registered from an unregistered state. Here, the time control unit 7 performs the precise examination on each of the tables 8 and 9 on a regular basis. In the case where an entry whose registered time (time stamp value) exceeds a predetermined time period (registered in the setting information storage area 3) exists, the time control unit 7 deletes the entry. Therefore, when a predetermined time elapses after the exchange process for MAC addresses is started for the first time, an operation to temporarily cancel the exchange process can be performed.

Further, as a security function, the router usually performs a filtering process for data packets. The filtering process performed most often is a filtering process on an IP address base at the router. The router performs precise examination on the source IP address and the destination IP address in a received IP packet according to the filtering conditions set in the router, and judges whether the packet is passed or blocked.

In the inter-segment exchange process (exchange process for MAC addresses) at the L2 switch 100 according to this embodiment mode, it can be judged for each of the source IP address and the destination IP address whether the exchange process is performed or not. Thus, the exchange process is performed with a granularity equal to granularity in the filtering process for each IP address.

In the L2 switch 100 according to the embodiment mode itself, there is no need to perform the setting of the filtering conditions using the IP address. However, as shown in FIG. 11, the registering process for the flow table 9 required for the exchange process is performed on the data packet that has passed through the virtual router.

Thus, once the data packet to be transferred between the hosts belonging to different segments meets the filtering conditions of the virtual router, the L2 switch 100 registers in the flow table 9 the entry relating to the data packet, which is then subjected to the exchange process.

Accordingly, there is no fear that the security of the router fails to function, which occurs when the L2 switch 100 exchanges the inter-host communication that should have been blocked according to the security conditions set in the router.

By a clearing process for a table entry after a predetermined time period due to the above-mentioned aging process, the following effects can be obtained. That is, by the aging process, each entry in the address table 8 and the flow table 9 is cleared after a predetermined time elapses. Accordingly, the change in filtering conditions made on a router side can be reliably reflected after the predetermined time period.

<Limitation on Exchange Process>

Further, as to the ICMP (Internet Control Message Protocol), instead of performing exchange at the L2 switch, the normal communication via the router must be performed. Thus, in the case where a protocol type of the IP header of the data packet is an “ICMP”, a configuration can be adopted in which the L2 switch 100 does not perform the exchange process (does not create the address table 8 or the flow table 9). The above-mentioned judgment process for the protocol type of the IP header is performed, for example, by the header analysis unit 5 of FIG. 10, and can be realized by such a configuration as not to perform the exchange process at the header editing unit 6 in the case where the protocol type is the “ICMP”.

<Advantages of the Embodiment Mode>

According to the embodiment mode described above, the following advantages can be obtained.

(1) It is unnecessary to install the expensive L3SW of a G (Giga) bps class as the WAN router. If the bandwidth demanded for the system is approximately several tens of Mbps, the inexpensive WAN router can be adopted.

(2) The WAN redundant structure can be attained with the WAN router connected across the L2SW being as the virtual router of the hot standby system. At this time, the hot standby protocol such as the VRRP can be used without being changed.

(3) As to the communication between the hosts connected under the L2 switch, high-speed communication reflecting the throughput of the L2 switch is possible not only in the case where the hosts belong to the same segment but also in the case where the hosts belong to different segments.

(4) The security function is not inhibited by the filtering at the router.

According to the present invention, data can be transferred through the communication between the hosts belonging to different segments without being passed through the router serving as the default gateway for the hosts.

What is claimed is:

1. A Layer 2 switching device which is connected to first and second hosts belonging to different LAN segments and to a router serving as a default gateway for the first and second hosts and forwards data to be transferred between the first and second hosts, comprising:
a flow table in which an entry is registered, the entry including an IP address of one host selected from the first and second hosts as a source IP address thereof and MAC and IP addresses of the other host as destination MAC and IP addresses thereof;
a converter that, in the case where data having the IP address of the one host set as the source IP address thereof and having the IP address of the other host set as the destination IP address thereof is received from the one host, converts the destination MAC address set in the data into the MAC address of the other host based on the entry in the flow table; and
a unit that sends out the data, which has the destination MAC address converted, to the other host.

2. The Layer 2 switching device according to claim 1, further comprising a flow table learning unit that, in the case where data having the IP address of the one host selected from the first and second hosts set as the source IP address thereof and having the MAC and IP addresses of the other host set as the MAC and destination IP addresses thereof is received via the router and sent to the other host, creates the entry including the source IP address and the MAC and destination IP addresses which are set in the data to register the entry in the flow table.

3. The Layer 2 switching device according to claim 1, further comprising:
an address table learning unit that, in the case where data to be transferred from the one host selected from the first and second hosts to the other host is received, registers an entry in an address table, the entry including a source MAC address and the destination IP address which are set in the data; and
a flow table learning unit that:
in the case where the data to be transferred from the one host to the other host is received via the router and sent to the other host, searches the address table by using the destination IP address in the data as a search key; and
when the MAC address included in a retrieved entry coincides with the destination MAC address in the data, creates an entry including the source IP address and the MAC and destination IP addresses which are set in the data to register the entry in the flow table.

4. The Layer 2 switching device according to claim 1, wherein the source MAC address set in the data is converted into a MAC address of the router corresponding to the segment to which the other host belongs.

5. The Layer 2 switching device according to claim 2, wherein the flow table learning unit creates the entry for only each of ports to be connected to the first and second hosts.

6. The Layer 2 switching device according to claim 1, further comprising a deletion unit that, in the case where a predetermined time has elapsed since an entry was newly registered or last updated in the flow table, deletes the entry.

7. The Layer 2 switching device according to claim 1, wherein the Layer 2 switching device forwards a particular kind of data within the data to be transferred from the one host selected from the first and second hosts to the other host, to the router, without a process performed by the converter.

8. A data exchange method using a Layer 2 switching device which is connected to first and second hosts belonging to different LAN segments and to a router serving as a default gateway for the first and second hosts and relays data to be transferred between the first and second hosts, the method comprising:
registering in a flow table an entry including an IP address of one host selected from the first and second hosts as a source IP address thereof and MAC and IP addresses of the other host as MAC and destination IP addresses thereof;
converting, in the case where data having the IP address of the one host set as the source IP address thereof and having the IP address of the other host set as the destination IP address thereof is received from the one host, the destination MAC address set in the data into the MAC address of the other host based on the entry in the flow table; and
sending out the data, which has the destination MAC address converted, to the other host.

9. The data exchange method using a Layer 2 switching device according to claim 8, further comprising, creating, in the case where data having the IP address of the one host selected from the first and second hosts set as the source IP address thereof and having the MAC and IP addresses of the other host set as the MAC and destination IP addresses thereof is received via the router and sent to the other host, the entry including the source IP address and the MAC and destination IP addresses which are set in the data to register the entry in the flow table.

10. The data exchange method using a Layer 2 switching device according to claim 8, further comprising:
registering, in the case where data to be transferred from the one host selected from the first and second hosts to the other host is received, in an address table an entry including a source MAC address and the destination IP address which are set in the data;
searching, in the case where the data to be transferred from the one host to the other host is received via the router and sent to the other host, the address table by using the destination IP address in the data as a search key; and
creating, when the MAC address contained in a retrieved entry coincides with the destination MAC address in the data, an entry including the source IP address and the MAC and destination IP addresses which are set in the data to register the entry in the flow table.

11. The data exchange method using a Layer 2 switching device according to claim 8, in which the source MAC address set in the data is converted into a MAC address of the router corresponding to the segment to which the other host belongs.

12. The data exchange method using a Layer 2 switching device according to claim 9, in which the entry to be registered in the flow table is created for only each of ports to be connected to the first and second hosts.

13. The data exchange method using a Layer 2 switching device according to claim 8, further comprising, deleting, in the case where a predetermined time has elapsed since an entry was newly registered or last updated in the flow table, the entry.

14. The data exchange method using a Layer 2 switching device according to 8, forwarding a particular kind of data within the data to be transferred from the one host selected from the first and second hosts to the other host, to the router, without performing a converting process of MAC address.
